(19) United States
(12) Patent Application Publication
(10) Pub. No.: US 2014/0303597 A1
(43) Pub. Date: Oct. 9, 2014

(54) Device and Method for the Administration of Solid Medicine to a Nursing Age Child

(71) Applicant: Tim Platt, Portland, OR (US)

(72) Inventor: Tim Platt, Portland, OR (US)

(21) Appl. No.: 13/855,927

(22) Filed: Apr. 3, 2013

(51) Int. Cl. A61J 7/00

(52) U.S. Cl. CPC A61J 7/0053
USPC 604/516; 604/57

(57) ABSTRACT

A device and method for administering a dose of particulate solid medication to a nursing age infant or child through a tube having one end held in a nursing nipple. The tube is held in a holder piece which also mounts the nipple aligned with the tube. The tube is resiliently bendable to hold the dose of medicine loaded therein prepatory to being released to pass down to said nipple. A child having the nipple in his or her mouth reflexively swallows the medicine passing out of the nipple.

### BACKGROUND OF THE INVENTION

This invention concerns the administration of a dose of medicine in solid form to infants and nursing age children. It is difficult to get an infant or small child to swallow medications since the medications do not taste or have the texture of something to eat or drink. The medication will sometimes be spit up rather than swallowed, and there may be a danger of choking.

There has heretofore been proposed to dispense liquid medicines using a baby bottle and nipple by providing a cavity into which a liquid medicine is measured, such that the medicine will be ingested by a baby nursing.

However, this approach does not solve the problem of administering solid medications. The present invention provides a device and method for safely administering solid medicine by inducing a swallowing reflex when accurately depositing the medicine in the infant's mouth where formula is normally ingested from a bottle.

It is the object of the present invention to provide a device and method for depositing solid medications into the mouth of an infant or nursing child and at the same time inducing a swallowing reflex to insure that the medicine is swallowed.

### SUMMARY OF THE INVENTION

The above object and other objects which will be understood by those skilled in the art are achieved by a device which includes a tube having one end held in a hole in the end of a nipple of a type used with baby bottles. The tube has an opposite end which may be positioned to allow a dose of solid medicine which is in a particulate for or has been comminuted to be able to be poured thereinto. The does is held at a location defined by a bend manually formed in the tube by a user. After the nipple has been received in the mouth of the baby or child, the bend is released to allow the dose to pass into the child's mouth and it will then be reflexively swallowed.

The tube is resiliently bendable and may be a plastic drinking straw, which is received in a holder piece provided with a hand grip.

The holder piece also has an elongated body with a forward projecting end portion disposed above the grip which end portion is shaped to receive the nursing nipple thereover with a frictional retention thereon. A lengthwise through opening is provided through the body aligned with the nipple held on the end portion and sized to receive the resiliently bendable tube which can be positioned with one end held by friction in an enlarged hole in the end of the nipple.

The tube may have a pleated section on an end segment positioned to the rear of the holder piece allowing it to be positioned and retained in an angled up position to present the tube rear open end to receive medicine which has been comminuted, as by being crumbled or powdered, by being poured into the open end of the tube to load the device with the solid medication.

The tube can then be bent up with the thumb of the gripping hand of the user at a point where the tube enters the rear end of the holder piece, causing the medication to drop down by gravity to be deposited behind the bend in the tube. This readies the device for use.

The nipple is then offered to the baby or nursing child with the tube inclined downwardly and the thumb released to allow the tube to straighten and the medication to drop down through and out the end of the nipple for ingestion.

A natural reflex to swallow insures swallowing of the medicine by the infant.

A regular baby bottle containing formula can then be offered to wash down the solid medication.

### DESCRIPTION OF THE DRAWINGS

FIG. 1 is a pictorial view from the rear of a device according to the invention.

FIG. 2 is a side view of the device shown in FIG. 1, depicting the initial loading of a dose of solid medication.

FIG. 3 is a side elevational view of the device shown in FIGS. 1 and 2 with the resiliently flexible tube bent up and held by the thumb of the gripping hand of the user to ready the deposited medication for administration.

FIG. 4 is a side view of the device shown in FIGS. 1-3, downwardly angled to be offered to an infant, shown with the thumb released and the medication allowed to pass out of the nipple and be swallowed by the infant.

FIG. 5 is an exploded pictorial view of the device shown in FIGS. 1-4 showing the components thereof.

FIG. 6 is a fragmentary sectional view of the holder, with the nipple and tube assembled together.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

Referring to the drawings, a device 10 according to the invention is comprised of a holder piece 12 having a hand grip 14 sized to be readily grasped by one hand of a user.

An upper elongate portion 16 has a nipple 18 fit to a reduced forward end 20 (FIG. 5) of the elongate portion 16 sized to create a frictional retention thereon.

The nipple 18 is of a type conventionally used with baby bottles, but with an enlarged opening 17 able to receive one end 22 of a resiliently bendable tube 24 such as a plastic drinking straw.

The tube 24 inserted into a lengthwise through hole 26 in the elongated portion 16 and advanced therein until the one end 25 enters a hole 28 in the nipple 18.

The hole 28 is enlarged from the conventional hole smaller than the hole used for nursing, sized so that the tube end 25 is gripped by the nipple 18 to be held substantially flush to the end 19 of the nipple 18 so as to not protrude significantly past the end thereof.

The tube 24 has a pleated section 30 near the opposite open end 32 to be readily bent and retained to create the angled up shape shown positioning the end 32 to enable medication to be poured therein.

A tube fold locator feature is provided as by a U shaped wire piece 34 fixed to the holder piece 12 extending across the top of the hole 26.

In use, a measured quantity of comminuted solid medication to be administered is poured into the tube 24 through the open end 32.

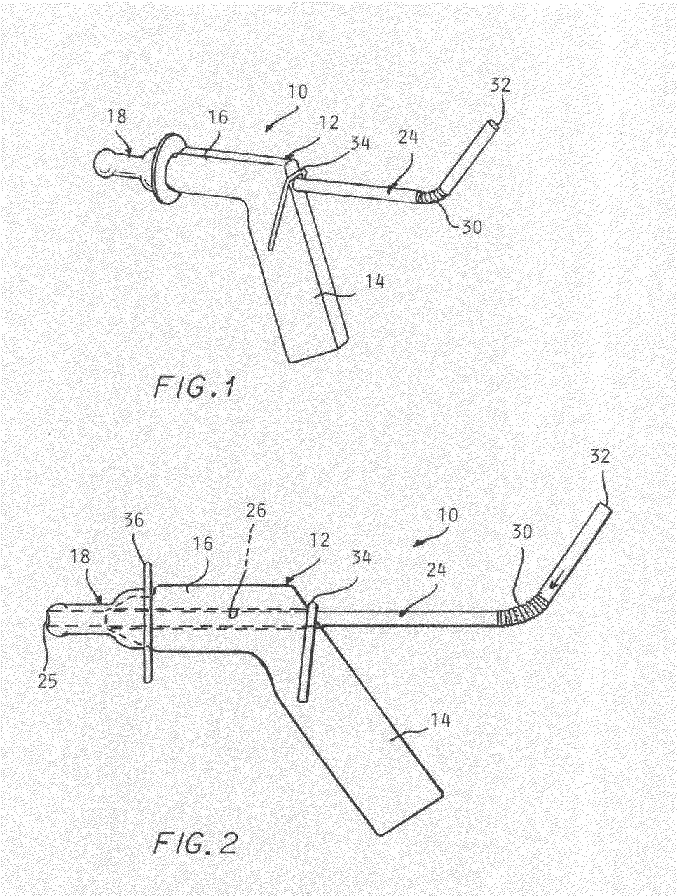

The holder 10 is held level as shown in FIG. 2 so that the medicine will remain in the tube pleated section 30.

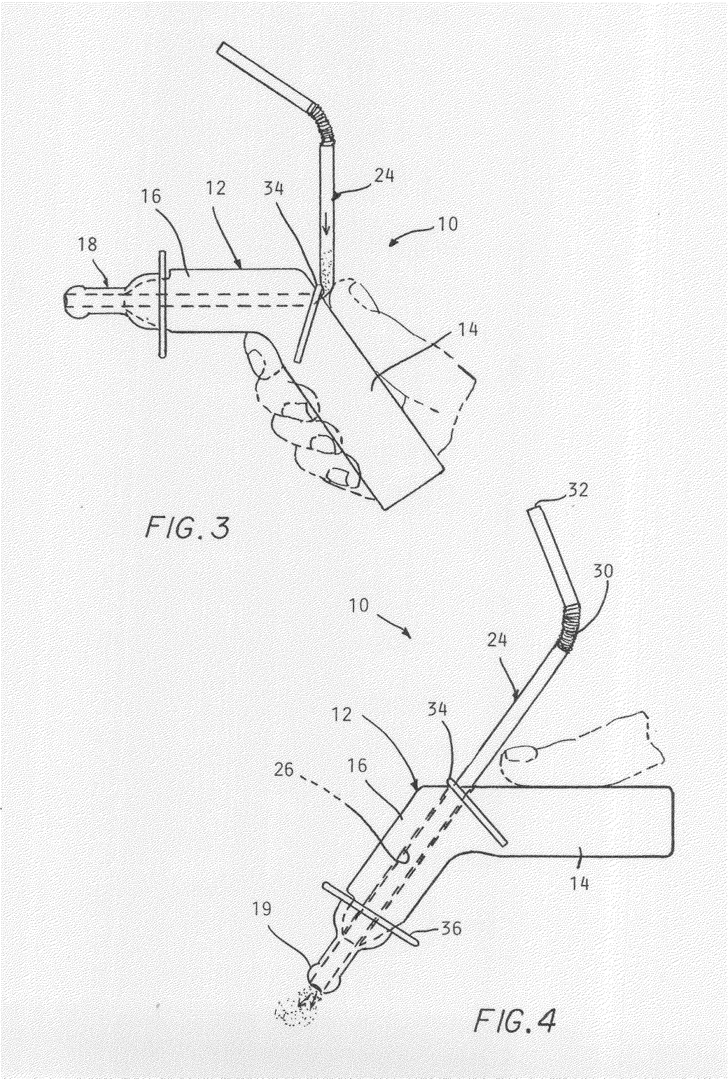

The user then bends up and holds the tube 24 in the folded up position shown in FIG. 3, the medicine, then dropping down to the point where the wire piece 34 is located.

This readies the device 10 for use.

The device 10 is angled down to offer the nipple 18 to the baby/toddler, and once the nipple 18 is safely in his or her mouth, the tube 24 is released to assume its normal straightened position shown in FIG. 4, allowing the medicine to pass through the tube 24 and into the baby/toddler's mouth.

The baby/toddler will reflexively swallow anything exiting the tube 24 so that the medicine will be safely ingested by the child.

The nipple 18 may be readily removed from the end 20 for cleaning.

The tube 24 is also easily removed and may be replaced with a fresh tube to insure a sanitary condition of the device 10.

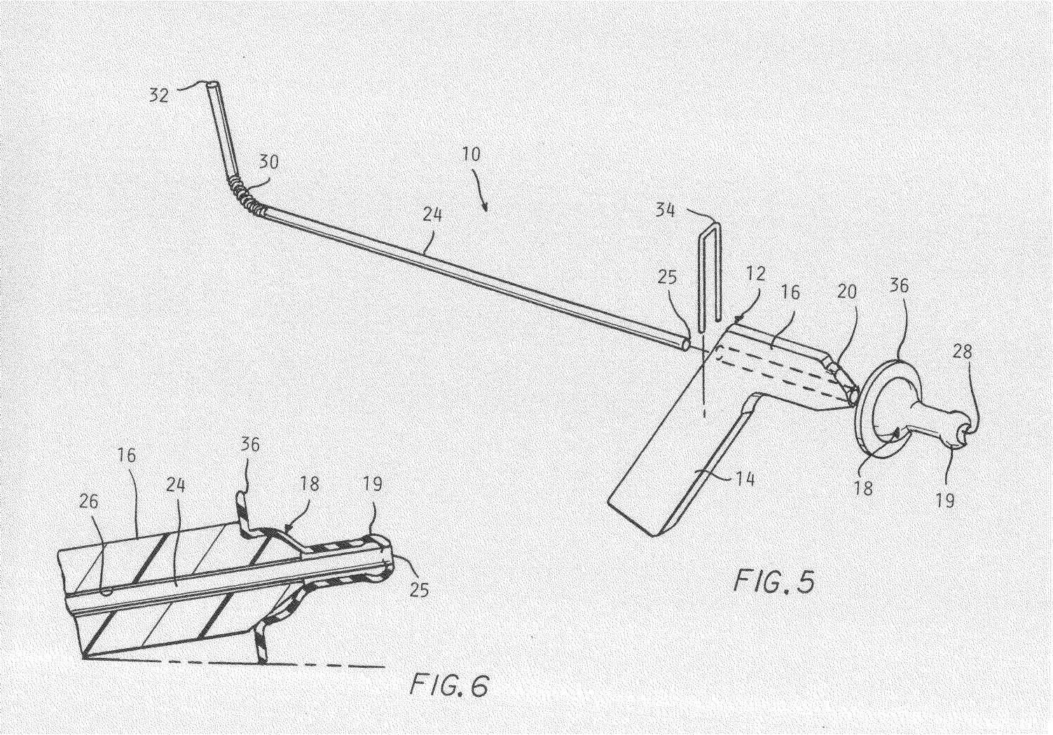

A flange 34 on the nipple 18 prevents the end of the nipple 19 from touching a surface when put down (FIG. 6).

1. A device for administrating a dose of particulate solid medication to a child of nursing age comprising:
a holder piece including a portion having a hole extending there through;
a resiliently bendable tube received in said hole in said holder piece;
a nursing nipple held on an end of said portion of said body substantially aligned with said hole;
said nipple having a hole in an end thereof able to receive one end of said resiliently bendable tube therein;
said tube having an opposite open end protruding out from an opposite end of said holder piece portion, enabling loading of a dose of said medicine into said opposite open end for dispensing out of said one end upon tilting said holder piece with said a tube therein downwardly.

2. The device according to claim 1 wherein said tube has a pleated section to enable stable positioning with said opposite end up for loading of said medicine thereinto.

3. The device according to claim 1 wherein said holder piece has a hand grip portion graspable with one hand of a user descending from an elongated portion comprising said first portion with said hole therein.

4. The device according to claim 3 further including a bend locator disposed at a point where said resiliently bendable tube protrudes out from said holder piece to facilitate bending up thereof by the thumb of a user's hand gripping said hand grip to cause said loaded medication dose to descend within said tube to said location and to be held by said bend at said location preparatory to administration of said medicine.

5. The device according to claim 1 wherein said nipple has a flange extending radially well beyond said body to prevent contact with a supporting surface, when said device is laid thereon.

6. The device according to claim 1 wherein said one end of said tube is gripped within said hole by said nipple to hold said one end at said nipple end.

7. The device according to claim 1 wherein said nipple frictionally grips said body portion to be held therein while being readily removable therefrom.

8. A method of administering a dose of particulate solid medicine to a nursing age child comprising:
positioning one end of a tube within an opening in the end of a nipple, and causing a measured dose of said solid medicine through said tube to said nipple end whereby a child having said nipple in his or her mouth will ingest said dose of solid medicine and thereafter by reflex swallow said medicine.

9. The method according to claim 8 wherein said tube has an opposite end in which said medicine is deposited preparatory to being passed by gravity down said tube and out said one end thereof.

10. The method according to claim 9 including releasably bending said tube at an intermediate location to hold said medicine in preparation to being passed from said one tube end and said nipple.

11. The method according to claim 10 including holding said tube in a hole in a holder piece; said nipple installed thereon aligned with said hole to receive medicine passed through said tube.

12. The method according to claim 11 further including forming a hand grip on said holder piece to facilitate handling thereof.
